(19) United States
(12) Patent Application Publication
(10) Pub. No.: US 2016/0129985 A1
(43) Pub. Date: May 12, 2016

(54) AIRCRAFT STRUCTURE HAVING CABLES LOCATED IN STRINGERS

(71) Applicant: AIRBUS GROUP INDIA PRIVATE LIMITED, Bangalore (IN)

(72) Inventors: Kishore Prasan MOHANTY, Bangalore (IN); Anand PUNTAMBEKAR, Bangalore (IN); Sivananda KAMSALA, Bangalore (IN)

(21) Appl. No.: 14/931,887

(22) Filed: Nov. 4, 2015

(30) Foreign Application Priority Data
Nov. 8, 2014 (IN) 5633/CHE/2014

(51) Int. Cl. B64C 1/06; B64C 3/18

(52) U.S. Cl. CPC B64C 1/064; B64C 3/182

(57) ABSTRACT

An aircraft structure having cables located in stringers is disclosed. According to one embodiment, the aircraft structure includes a stringer having a hollow channel. Further, one or more cables are located within the hollow channel. In one example, the one or more cables are capable of carrying a number of signals.

### RELATED APPLICATIONS

Benefit is claimed under 35 U.S.C. 119(a)-(d) to Foreign application Ser. No. 5633/CHE/2014 filed in India entitled “AIRCRAFT STRUCTURE HAVING CABLES LOCATED IN STRINGERS”, on Nov. 8, 2014, by AIRBUS GROUP INDIA PRIVATE LIMITED, which is herein incorporated in its entirety by reference for all purposes.

### TECHNICAL FIELD

Embodiments of the present subject matter generally relate to cables in aircrafts, and more particularly, to an aircraft structure having cables located in stringers.

### BACKGROUND

An aircraft includes a plurality of electrical and/or optical cables used for transmitting electrical energy or information, commands or signals between various components of the aircraft. These cables may run across length and breadth of the aircraft to ensure various functions. Typically, these cables may be secured through supports, such as installation brackets, fasteners and the like. The aircraft may include a significant number of supports (e.g., few thousands of supports) which makes the installation of the supports complex and may also result in an increase in lead time during design and manufacturing processes of the aircraft. Also, installation of these supports may increase deviations from standard design principles, non-conformities and may generate subsequent non-qualities or errors in assembly line. In addition, these supports add significant weight to the aircraft and make the aircraft assembly process lengthy and costly.

### SUMMARY

An aircraft structure having cables located in stringers are disclosed. According to one aspect of the present subject matter, the aircraft structure includes a stringer having a hollow channel. Further, one or more cables (e.g., electrical and optical cables) are located within the hollow channel. In one example, the one or more cables are capable of carrying a number of signals.

According to another aspect of the present subject matter, the aircraft structure includes a stringer having a first hollow channel. Further, foam is located within the first hollow channel. Furthermore, the foam has a second hollow channel. In addition, one or more cables are located within the second hollow channel. In one example, the one or more cables are capable of carrying a number of signals.

The technique disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a perspective view of a portion of a stringer including a cable, according to one embodiment;

FIG. 2 illustrates a cross-sectional view of a stringer that is partially filled with foam, according to one embodiment.

FIG. 3 illustrates an aircraft equipment connected to the cable placed in the stringer, according to one embodiment; and

FIG. 4 illustrates a portion of an aircraft fuselage including a number of stringers, according to one embodiment.

The drawings described herein are for illustration purposes only and are not intended to limit the scope of the present disclosure in any way.

### DETAILED DESCRIPTION

In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

An aircraft includes a plurality of cables (e.g., electrical and optical cables) that transmit electrical energy or information, commands or signals between various components (e.g., flight management system (FMS), fuel system and aircraft engines) in the aircraft. These cables follow a specific path in the aircraft depending on the components connected. For laying these cables in an orderly way, supports in the form of brackets, fasteners and the like are employed. These supports are attached to suitable attachment surfaces in the aircraft at specific intervals. As a result, a significant number of supports (e.g., few thousands of supports) may be used which makes the installation of the supports complex and increases lead time in design and manufacturing of the aircraft. Further, these supports may add significant weight to the aircraft.

The example technique disclosed herein proposes an aircraft structure having cables placed in stringers. The aircraft structure (e.g., a skin on a fuselage of an aircraft, a skin on a wing of the aircraft, a frame of the aircraft and a rib of the aircraft) includes a plurality of longitudinal stringers (also known as stiffeners). These stringers have a hollow channel throughout its length. in one example, one or more cables are routed in the hollow channel in the stringers. The cables are then taken out near extremities of the stringers for connecting to components in the aircraft. This technique eliminates the need of external supports to install the cables in aircrafts.

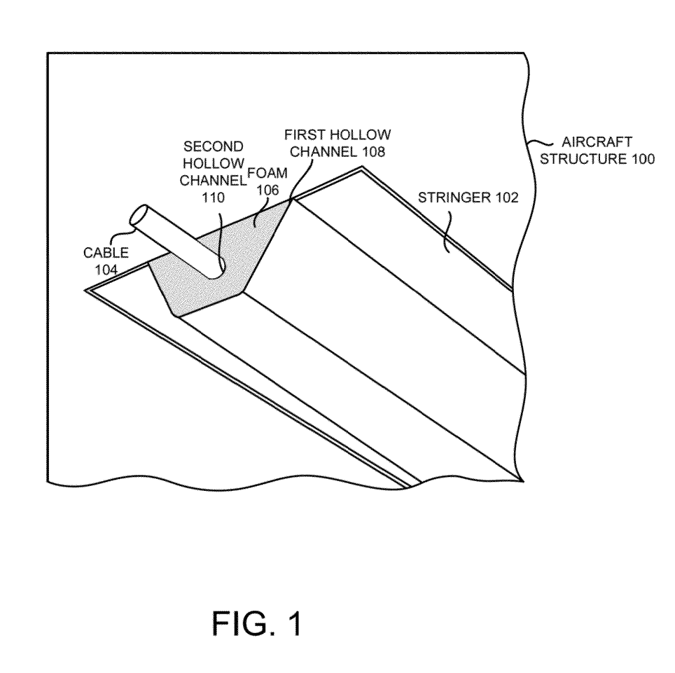

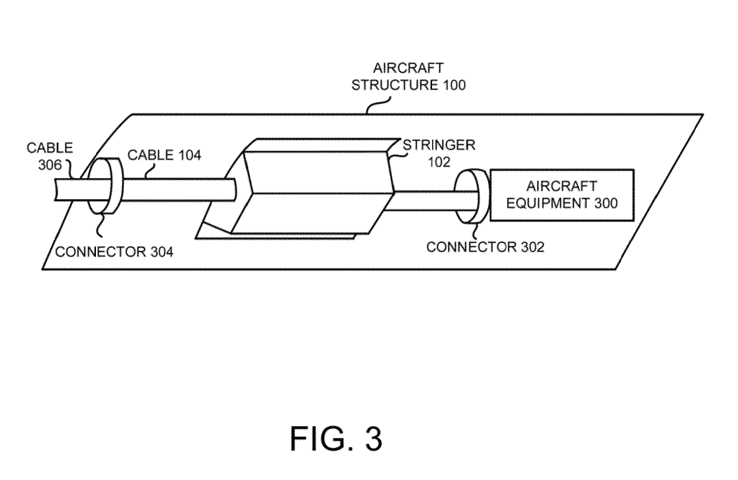

Referring now to FIG. 1, which illustrates a perspective view of a stringer 102 including a cable 104, according to one embodiment. Particularly, FIG. I illustrates a portion of an aircraft structure 100. Exemplary aircraft structure includes a skin on a fuselage of an aircraft, a skin on a wing of the aircraft, a frame of the aircraft, a rib of the aircraft and the like. As shown in FIG. 1 the stringer 102 is attached to interior of the aircraft structure 100. In one example, a number of stringers may be attached to the aircraft structure, as shown in FIG. 3.

Further as shown in FIG. 1, the stringer 102 includes a first hollow channel 108. For example, the first hollow channel 108 extends throughout the length of the stringer 102. Furthermore, foam 106 (e.g., insulation foam) is located within the first hollow channel 108. For example, any other supporting material other than the foam 106 may be used within the stringer 102. In the example illustrated in FIG. 1, the first hollow channel 108 is completely filled with the foam 106. In one example, the foam 106 is fabricated in shape of the first hollow channel 108.

Also as shown in FIG. 1, the foam 106 has a second hollow channel 110. In one example, a narrow slit is cut along length of the foam 106 to create the second hollow channel 110. Further, the cable 104 is placed within the second hollow channel 110. In one example, one or more cables may be placed within the second hollow channel 110. The cables are capable of carrying a number of signals. Exemplary signal includes an information signal, a power signal and the like.

Upon placing the cable 104 in the second hollow channel 110, the foam 106 along with the cable 104 is placed in the stringer 102 using a draw wire technique. In this technique, a draw wire is passed from one extremity of the stringer 102 to the other extremity. Further, the draw wire is connected to one end of the cable 104. Furthermore, the cable 104 along with the foam 106 is drawn into the stringer 102 using the draw wire. In one example, the outer surfaces of the foam 106 are covered with a film (e.g., a polyamide based film) to reduce relative friction between the foam 106 and the inner surface of the first hollow channel 108 during installation. In another example, the foam 106 and the cable 104 may be individually inserted into the stringer 102.

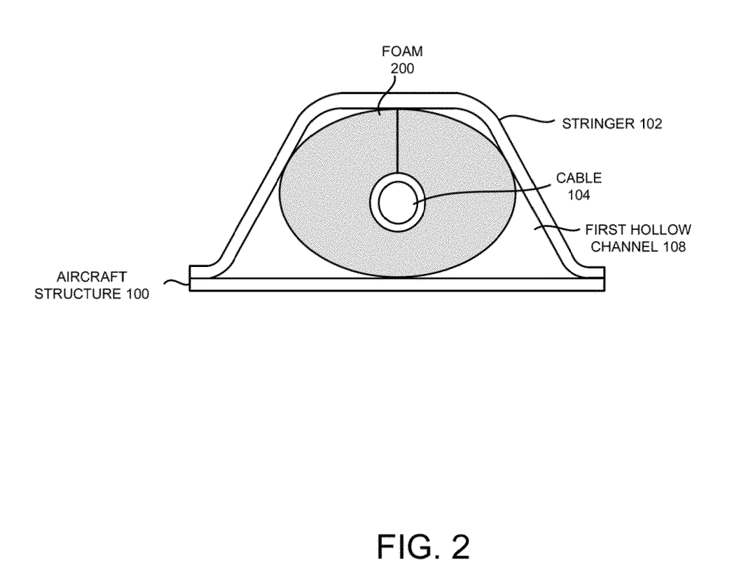

In one example embodiment, the cables may be placed within the first hollow channel 108 in the stringer 102 without the foam 106, as shown in FIG. 3. In another example, the cables may be placed within the first hollow channel 108 in the stringer 102 that is partially filled with foam (e.g., foam 200 shown in FIG. 2).

Referring now to FIG. 2, which illustrates a cross-sectional view of the stringer 102 that is partially filled with foam 200. In the example illustrated in FIG. 2, the foam 200 has an elliptical cross-section. For example, the foam 200 may include other cross-section shapes, such as circular and the like. The cross-sectional shape of foam placed within a stringer may be suitably modified to optimize design and manufacturing.

Referring now to FIG. 3, which illustrates an aircraft equipment 300 connected to the cable 104 placed in the stringer 102, according to one embodiment. In the example illustrated in FIG. 3, the cable 104 is placed in the stringer 102 without foam. As shown in FIG. 3, a connector 302 is attached to one end of the cable 104. Further as shown in FIG. 3, an aircraft equipment 300 is connected to the cable 104 via the connector 302. Exemplary aircraft equipment includes FMS, fuel system, aircraft engines, in-flight entertainment systems, navigation systems and the like.

Furthermore as shown in FIG. 3, a connector 304 is attached to other end of the cable 104. In the example illustrated in FIG. 3, a cable 306 is attached to the cable 104 via the connector 304. Similarly, one or more cables located in stringers may be connected to other cables or aircraft equipments via connectors.

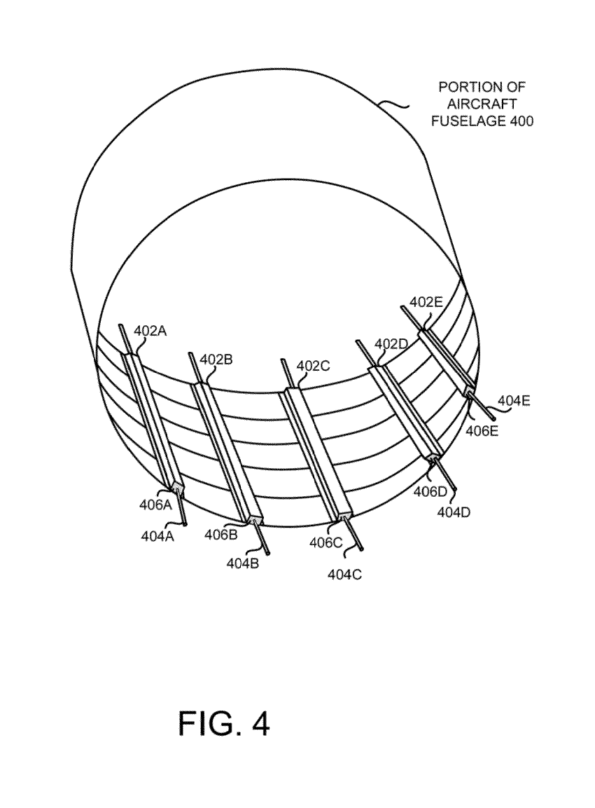

Referring now to FIG. 4, which illustrates a portion of an aircraft fuselage 400 including a number of stringers 402A-E, according to one embodiment. As shown in FIG. 4, the stringers 402A E are attached to the interior of the aircraft fuselage 400. Further, each of the stringers 402A-E has an associated hollow channel. Furthermore, cables 404A-E are located within the hollow channel associated with the stringers 402A-E, respectively. The cables 404A-E are capable of carrying a number of signals. Exemplary signal includes information signal and/or power signal. In addition as shown in FIG. 4, foam 406A-E are placed around the cables 404A-E, respectively.

In various embodiments, the technique described in FIGS. 1 through 4 proposes an aircraft structure having cables located in stringers. The proposed technique utilizes an existing structural member of the aircraft for placing cables without usage of any external supporting components, such as brackets, fasteners and the like. Further, the proposed technique enables routing of co-axial and optical cables or multiple optical cables together. Also, weight of the electrical system in the aircraft is significantly reduced and hence contributes to fuel saving for the aircraft.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. An aircraft structure, comprising:
a stringer having a hollow channel; and
one or more cables located within the hollow channel, wherein the one or more cables are capable of carrying a number of signals.

2. The aircraft structure of claim 1, wherein the number of signals are selected from the group consisting of an information signal and a power signal.

3. The aircraft structure of claim 1, wherein the stringer is capable of being attached to one of a skin on a fuselage of an aircraft, a skin on a wing of the aircraft, a frame of the aircraft, and a rib of the aircraft.

4. The aircraft structure of claim 1, further comprising:
a number of stringers, wherein each of the number of stringers has an associated hollow channel.

5. The aircraft structure of claim 1, wherein the stringer comprises:
foam located within the hollow channel, wherein the one or more cables are located within the foam.

6. The aircraft structure of claim 1 wherein the cables are selected from the group consisting of electrical cables and optical cables.

7. An aircraft structure, comprising:
a stringer having a first hollow channel;
foam located within the first hollow channel, wherein the foam has a second hollow channel; and
one or more cables are located within the second hollow channel, wherein the one or more cables are capable of carrying a number of signals.

8. The aircraft structure of claim 7, wherein the number of signals are selected from the group consisting of an information signal and a power signal.

9. The aircraft structure of claim 7, wherein the stringer is capable of being attached to one of a skin on a fuselage of an aircraft, a skin on a wing of the aircraft, a frame of the aircraft, and a rib of the aircraft.

10. The aircraft structure of claim 7, further comprising:
a number of stringers, wherein each of the number of stringers has an associated first hollow channel.

11. The aircraft structure of claim 7, wherein the cables are selected from the group consisting of electrical cables and optical cables.
